(19) United States
(12) Patent Application Publication
(10) Pub. No.: US 2011/0196519 A1
(43) Pub. Date: Aug. 11, 2011

(54) CONTROL OF AUDIO SYSTEM VIA CONTEXT SENSOR

(75) Inventors: Sami Khoury, Seattle, WA (US); Tom Butcher, Seattle, WA (US)

(73) Assignee: MICROSOFT CORPORATION, Redmond, WA (US)

(21) Appl. No.: 12/702,644

(22) Filed: Feb. 9, 2010

(51) Int. Cl. G06F 17/00

(52) U.S. Cl. 700/94

(57) ABSTRACT

Embodiments related to the control of a computing device via an audio output apparatus having a context sensor are provided. One disclosed embodiment provides a computing device configured to receive a first input from a context sensor on an audio output apparatus, and to activate a selected listening mode based on the first input, wherein the listening mode defining a mapping of a set of context sensor inputs to a set of computing device functionalities. The storage subsystem further includes instructions executable by the logic subsystem to receive a second input from the context sensor after activating the selected listening mode, and in response, to selectively trigger execution of a computing device functionality from the set of computing device functionalities based on the second input, and to transform an audio signal supplied to the audio output apparatus based on the selected computing device functionality.

### BACKGROUND

Many computing devices, such as personal media players, desktops, laptops, and portable telephones, are configured to provide an audio signal to an audio output device, such as a headphone set, speakers, etc. In many cases, the communication between the computing device and audio output device is unidirectional, in that the audio output device receives the audio signal but does not provide any signal to the computing device. Playback-related functionalities in such devices are generally actuated via a user input associated with the computing device.

Some audio output devices may be configured to conduct bi-directional communication with a computing device. For example, some headphone sets may have a microphone that acts as a voice receiver for a cell phone. However, the audio signal provided by the headphone set to the computing device contains only the user's voice information.

### SUMMARY

Accordingly, various embodiments related to the control of a computing device via an audio output apparatus having a context sensor are provided. For example, one disclosed embodiment provides a computing device comprising a logic subsystem and a storage subsystem including instructions executable by the logic subsystem to receive a first input from the context sensor, and to activate a selected listening mode selected from a plurality of listening modes based on the first input, wherein the listening mode defining a mapping of a set of context sensor inputs to a set of computing device functionalities. The storage subsystem further includes instructions executable by the logic subsystem to receive a second input from the context sensor after activating the selected listening mode, and in response, to selectively trigger execution of a selected computing device functionality from the set of computing device functionalities based on the second input. The instructions are further executable to transform an audio signal supplied to the audio output apparatus based on the selected computing device functionality.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 shows a schematic depiction of an embodiment of an interactive audio system including a computing device and an audio output apparatus.

FIG. 2 shows an illustration of the audio output apparatus of the embodiment of FIG. 1.

FIG. 3 illustrates an embodiment of a set of listening modes selectable by a computing device based upon feedback received from one or more context sensors on an audio output apparatus.

FIG. 4 shows a flow diagram depicting an embodiment of a method for managing a set of predetermined listening modes in the computing device shown in FIG. 1.

FIG. 5 shows a flow diagram depicting another embodiment of a method for managing a set of predetermined listening modes in a computing device.

### DETAILED DESCRIPTION

Embodiments are disclosed herein that relate to controlling a computing device configured to provide an audio signal to an audio output apparatus via signals received from a context sensor incorporated into or otherwise associated with the audio output apparatus. The term “context sensor” as used herein refers to a sensor that detects conditions and/or changes in conditions related to the audio output apparatus itself and/or a use environment of the audio output apparatus. Examples of suitable computing devices include, but are not limited to, portable media players, computers (e.g. laptop, desktop, notebook, tablet, etc.) configured to execute media player software or firmware, cell phones, portable digital assistants, on-board computing devices for automobiles and other vehicles, etc. Examples of suitable audio output apparatuses include, but are not limited to, headphones, computer speakers, loudspeakers (e.g. in an automobile stereo system), etc.

In some embodiments, signals from the context sensor or sensors are used to select a listening mode on the computing device, wherein the listening mode specifies a set of functionalities on the computing device related to control of the audio signal provided by the computing device. Further, the signals from the context sensor also may be used to select functionalities within a listening mode. As described in more detail below, the audio output apparatus may include one or more of a motion sensor, a touch sensor, a light sensor, a sound sensor, and/or any other suitable context sensor.

The use of context sensors with an audio output apparatus may allow various rich user experiences to be implemented in such a manner that feedback regarding body motions (stationary, jogging/running, etc.), local environmental conditions (e.g. ambient noise, etc.), and other such factors may be utilized to select an audio listening mode experience tailored to that environment. Further, such selection may occur automatically based upon the context sensor signals, without requiring a user to interact with a user interface on the computing device to select the mode. Alternatively or additionally, selection may be based upon predetermined user interactions with the audio output apparatus and/or sensors.

Moreover, after a listening mode is activated, feedback signals from one or more context sensors may be used to control the audio signal provided to the audio output apparatus by selecting functionalities specific to each listening mode. The feedback signals may correspond to natural movements of a user as well as environmental sensory signals indicative of the conditions of the audio output apparatus' surrounding environment.

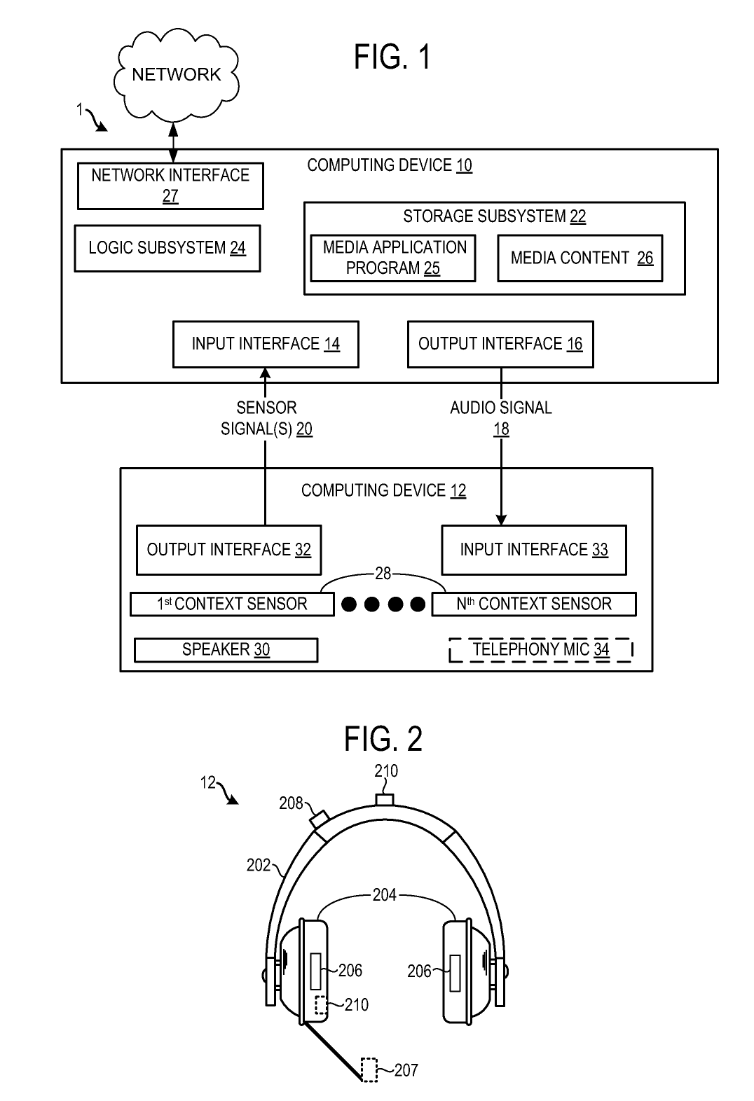

FIG. 1 shows a schematic depiction of an embodiment of an interactive audio system 1. The interactive audio system includes a computing device 10 configured to provide an audio signal to an audio output apparatus 12. The computing device may comprise a media player (e.g., a personal media player), a laptop computer, a desktop computer, a portable telephone, a stereo receiver, video game console, television, combinations of any of these devices, and/or any other suitable device configured to produce an audio output signal for an audio output apparatus 12. Likewise, the audio output apparatus 12 may take any suitable form, including but not limited to such devices as a pair of personal headphones, a telephony headset, one or more loudspeakers (e.g. a vehicle sound system), etc.

The computing device 10 and the audio output apparatus 12 may communicate through a wired or wireless communication mechanism. Examples include, but are not limited to, standard headphone cables, universal serial bus (USB) connectors, Bluetooth or other suitable wireless protocol, etc. The computing device 10 includes an input interface 14 and an output interface 16 to enable wired or wireless communication with the audio output apparatus 12. In this way, the computing device 10 may not only send an audio signal 18 to the audio output apparatus 12 but may also receive one or more sensor signal(s) 20 from the audio output apparatus 12.

The computing device further includes a storage subsystem 22 and a logic subsystem 24. Logic subsystem 24 may include one or more physical devices configured to execute one or more instructions. For example, the logic subsystem may be configured to execute one or more instructions that are part of one or more programs, routines, objects, components, data structures, or other logical constructs. Such instructions may be implemented to perform a task, implement a data type, transform the state of one or more devices, or otherwise arrive at a desired result. The logic subsystem may include one or more processors that are configured to execute software instructions. Additionally or alternatively, the logic subsystem may include one or more hardware or firmware logic machines configured to execute hardware or firmware instructions.

Storage subsystem 22 may include one or more physical devices configured to hold data and/or instructions executable by the logic subsystem to implement the methods and processes described herein. When such methods and processes are implemented, the state of storage subsystem 22 may be transformed (e.g., to hold different data). Storage subsystem 22 may include removable media and/or built-in devices. Storage subsystem 22 may include optical memory devices, semiconductor memory devices, and/or magnetic memory devices, among others. Storage subsystem 22 may include devices with one or more of the following characteristics: volatile, nonvolatile, dynamic, static, read/write, read-only, random access, sequential access, location addressable, file addressable, and content addressable. In some embodiments, logic subsystem 24 and storage subsystem 22 may be integrated into one or more common devices, such as an application specific integrated circuit or a system on a chip.

A media application program 25, such as a digital media player, may be stored on the storage subsystem 22 and executed by the logic subsystem 24. Among other things, the media application program may be configured to provide an audio signal to the output interface 16. Further, media content 26, such as audio, audio/video, etc. content may be stored in storage subsystem 22.

The computing device 10 may further include a network interface 27 configured to connect to a wide area network, such as a data network and/or cellular phone network, to thereby receive content such as streaming audio and/or video communications from one or more remote servers (not shown).

The depicted audio output apparatus 12 includes a plurality of context sensors 28, but it will be understood that other embodiments may include a single context sensor. Examples of suitable context sensors include, but are not limited to, a motion sensor (e.g., an accelerometer), a light sensor, a touch sensor (e.g., a capacitive touch sensor, a resistive touch sensor, etc.), and a sound sensor (e.g., an omnidirectional microphone). Each context sensor may be configured to generate and send an information stream to the computing device 10 for use by programs, such as a media player program, running on the computing device, as described in more detail below. As illustrated, the audio output apparatus 12 includes a speaker 30 configured to receive the audio signal from the output interface 16 and to produce sounds from the audio signal. It will be appreciated that in other embodiments the audio output apparatus may include a plurality of speakers. Additionally, the audio output apparatus 12 includes an output interface 32 for providing sensor signals to the computing device 10, as well as for sending signals from an optional telephony microphone 34 to the computing device. The audio output apparatus further comprises an input interface 33 for receiving an audio signal from the computing device 10.

FIG. 2 shows an embodiment of the audio output apparatus 12. The audio output apparatus 12 is illustrated as a personal headphone apparatus. The depicted audio output apparatus 12 comprises a body 202 supporting two earpieces 204 each having an integrated speaker 206. However, the audio output apparatus 12 may take any other suitable form, including but not limited to earbud-style headphones, a single-speaker headset, one or more loudspeakers (e.g. in a car sound system), etc. The depicted audio output apparatus 12 further comprises a unidirectional microphone 207 that acts as a receiver for a telephone call to enable telephony communications.

As mentioned above, the audio output apparatus 12 may comprise various context sensors, such as one or more motion sensors and/or environmental sensors, configured to provide feedback signals to the computing device 10. Signals from such sensors may then be used as desired by the computing device 10 to enable various rich user experiences not possible without such sensor feedback. The depicted audio output apparatus 12 comprises a motion sensor 208, such as a tilt sensor, a single or a multi-axis accelerometer, or a combination thereof, coupled to the body 202.

The motion sensor 208 may be configured to generate an information stream corresponding to the movement of the audio output apparatus, and to send the stream to the computing device 10. Various electrical characteristics of the information stream, such as amplitude changes, frequencies of amplitude changes, etc. may be interpreted as inputs by the computing device 10. In some embodiments, logic circuitry (not shown) may be provided on the audio output apparatus 12 to process raw signals from sensor 208 and/or environmental signals to thereby provide the computing device 10 with a processed digital or analog sensor signal information stream. In other embodiments, the raw signal from the context sensor may be provided to the computing device 10.

Continuing with FIG. 2, the audio output apparatus 12 further comprises an environmental sensor 210 coupled to the body that is configured to generate and send a second information stream to the input interface 14. The environmental sensor 210 may comprise any suitable sensor or sensors configured to detect environmental conditions. Examples include, but are not limited to, sound sensor, light sensors, and touch sensors. For example, a sound sensor, such as an omnidirectional microphone configured to detect ambient sounds and to provide an ambient sound signal to the computing device so that the computing device may react to sounds in the user's environment. As a more specific example, if a user is listening to music and another person starts talking to the user, the other person's voice may be detected by the sound sensor and then provided to the computing device as a feedback signal. The computing device may then detect the change in the signal from the sound sensor in any suitable manner, such as by pausing music playback muting a local microphone, etc.

In other examples, the environmental sensor may be a touch sensor or a light sensor. The touch sensor may be configured to touch a user's skin when the audio output apparatus is in use. In this manner, a touch signal may be used to determine whether a user is currently using the audio output apparatus via the presence or absence of a touch on the sensor. A light sensor may be used in the same manner, such that a light intensity reaching the light sensor changes when a user puts on or takes off the audio output apparatus 12. In some embodiments, a plurality of such sensors may be used in combination to increase a certainty in a determination that a user is wearing or not wearing the audio output apparatus 12.

As mentioned above, output from motion and/or environmental sensors on audio output apparatus 12 may be used by in some embodiments to provide various rich user experiences, such as activity-specific listening modes that are triggered via sensor outputs. This is in contrast to current noise-cancelling headphones, which do not provide an ambient sound signal to an audio signal source (e.g. a computing device such as a media player), but instead process the ambient sound signal and produce a noise-cancelling signal via on-board electronics.

The term “listening mode” as used herein refers to a mapping of a set of context sensor inputs to a set of computing device functionalities. It will be understood that the term “context sensor inputs” and the like refer to a segment of a context sensor output stream that corresponds to a recognized sensor output signal pattern.

Each listening mode may be triggered by receipt of set of one or more corresponding context sensor inputs from one or more context sensors. Likewise, a set of functionalities that are operative in each listening mode also may be mapped to a corresponding set of context sensor inputs. As a more specific example, a motion sensor signal that results from a user jogging while wearing the audio output apparatus 12 may be recognized as commonly occurring during aerobic exercise. Therefore, upon detecting such a motion sensor signal, the computing device 10 may switch to this mode. Further, functionalities specific to the aerobic activity mode also may be triggered by other sensor inputs. For example, the aerobic exercise mode may include a tempo-selecting functionality that selects audio tracks of appropriate tempos for warm-up, high-intensity, and cool-down phases of a workout. It will be understood that these examples of listening modes and functionalities within a listening mode are presented for the purpose of example, and are not intended to be limiting in any manner. It will further be understood that some listening modes, and/or functionalities within a listening mode, may be activated by feedback from more than one context sensor.

The computing device 10 may select a listening mode in any suitable manner. For example, in some embodiments, the computing device 10 may receive one or more feedback signals, and then determine a confidence level for each listening mode, wherein the confidence level is higher where the received inputs more closely match the expected inputs for a listening mode. In this manner, the listening mode with the highest confidence level may be selected. In other embodiments, any other suitable method may be used to select a listening mode.

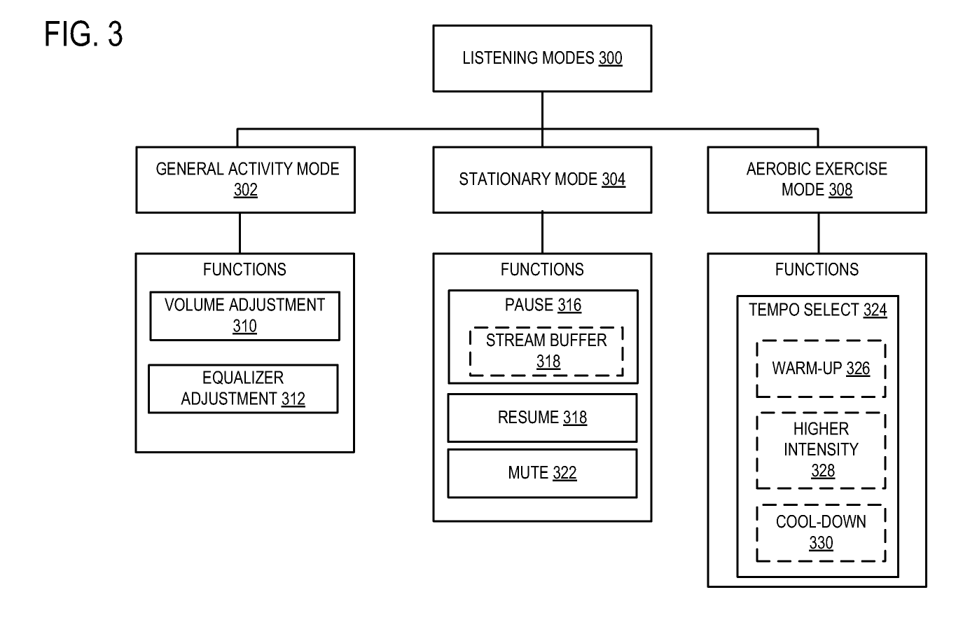

FIG. 3 shows a schematic depiction of an embodiment of an example set of listening modes 300. The depicted listening modes include a general activity mode 302, a stationary mode 304, and a specific activity mode in the form of an aerobic exercise mode 308. It will be appreciated that the depicted listening modes are shown for the purpose of example, and are not intended to be limiting in any manner, as any other suitable mode and/or number of supported modes may be used.

The general activity mode 302 may be activated by the computing device when the inputs from the motion and/or environmental sensors indicate that the user is moving, but that no recognized specific activity can be detected from the sensor inputs. FIG. 3 also shows two non-limiting examples of computing device functionalities corresponding to the general activity mode, in the form of a volume adjustment function 310 and an equalizer adjustment function 312. The volume adjustment function 310 and equalizer adjustment function 312 may be triggered, for example, by changes in ambient noise volume and/or ambient noise frequency distribution. As a more specific example, if a signal from an ambient sound-detecting microphone indicates that ambient noise is increasing, the computing device may increase a volume of an audio signal that is being provided to the audio output apparatus. Likewise, if ambient noise is decreasing, the computing device may decrease the volume of the audio signal. Further, the equalizer adjustment function may be configured to increase or decrease the power of the audio signal at specific frequency ranges. It will be understood that the depicted functionalities are shown for the purpose of example, and are not intended to be limiting in any manner.

The stationary activity mode 304 may be activated by the computing device when the inputs from the motion and/or environmental sensors indicate that the user is seated or otherwise stationary. Such a mode may be active, for example, where a user is studying, working, etc. As such, the set of computing device functionalities corresponding to the stationary mode include functionalities that allow a user to hear and interact with other people in the environment with greater ease than conventional audio output devices.

For example, the depicted set of functionalities in the stationary activity mode includes an environmental voice-triggered pause function 316 and associated resume function 318. Further, the environmental voice-triggered pause function may include a stream buffer function 320. The environmental noise-triggered pause function 316 is configured to pause or stop audio playback when, for example, a person speaking is detected in a signal from an environmental sound sensor. This may help the user of the audio output apparatus to hear the person speaking with greater ease. The resume function 318 is configured to resume playback once the signal from the environmental sound sensor indicates that the external speaking has ceased for a predetermined period of time. The stream buffer function 320 may buffer a segment of streamed media that begins at the location in the media stream at which playback was paused. This may help to ensure that there is no startup lag associated with the resume function 318 when playback resumes.

The stationary activity mode 304 may further include a mute function 322. The mute function 322 may be configured to mute a local telephony microphone when an ambient sound sensor detects another person speaking, and to stop muting once the other person has stopped speaking. It will be understood that these specific functionalities of the stationary activity mode are presented for the purpose of example, and are not intended to be limiting in any manner.

As mentioned above, FIG. 3 also illustrates a specific activity mode 306 that may include functionalities configured to compliment the user's performance of specific activities. The depicted specific activity mode 306 is an aerobic exercise mode, and may be selected when the computing device receives signals from motion and/or environmental signals that indicates that the user is jogging or running. For example, a regular pattern of relatively high-frequency footsteps may be detected by a motion sensor and/or an environmental sound sensor. The specific activity mode 306 comprises a tempo-selection function 324 that selects audio tracks based upon a current aerobic workout segment. For example, slower tempo music may be selected during a warm-up phase 326 and cool-down phase 330, while faster tempo music may be selected during a higher intensity phase 328. While a single specific activity mode is shown for the purpose of example, it will be understood that a plurality of specific activity modes may be used. It will further be understood that the depicted specific activity mode and set of specific activity functionalities are shown for the purpose of example, and are not intended to be limiting in any manner.

In addition to the specific functionalities shown in FIG. 3 for each listening mode, other functionalities may be global to all listening modes. For example, a stop functionality may be globally implemented when, for example, motion and/or environmental feedback signals indicate that the audio output apparatus has been removed from a user's head. As a more specific example, if the audio output apparatus is a headphone set comprising a light sensor and/or touch sensor, and a signal or signals from such sensors indicates that a user has removed the headphones, the computing device may be configured to stop playback. Likewise, a resume functionality may be globally implemented when motion and/or environmental context sensors indicate that the audio output apparatus has been placed back on a user's head after having been removed. It will be understood that these global functionalities are presented for the purpose of example and are not intended to be limiting in any manner.

While the selection of a listening mode is discussed above in the context of feedback signals that give information on an activity that a user is currently performing, it will be understood that listening modes and/or functionalities within a listening mode may be selected based upon input motions that do not arise from ordinary user activities, but rather that involve user intent to perform correctly. This may allow a user to select a desired listening mode by performing “natural user interface” inputs, such as motions of the head, etc., to select a desired listening mode. More generally, it will be understood that any suitable input or set of inputs from one or more context sensors may be used in selection of a listening mode and of a functionality within a listening mode.

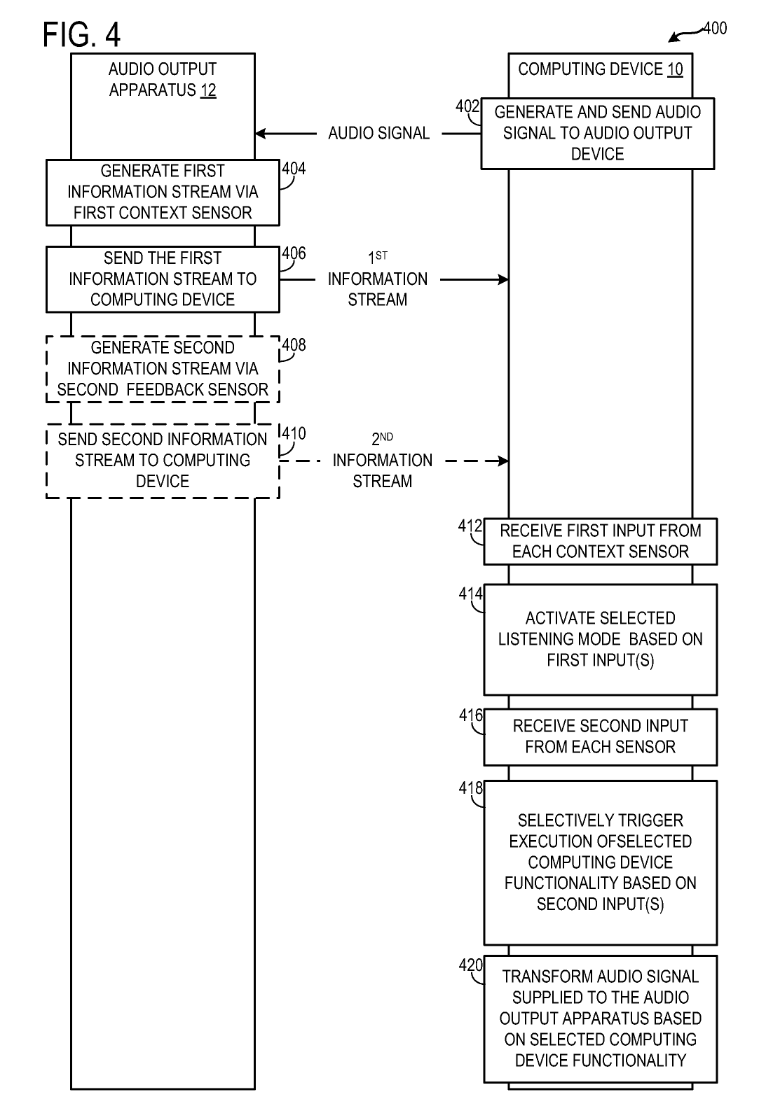

FIG. 4 shows a flow diagram 400 depicting an embodiment of a method for managing a set of predetermined listening modes on a computing device configured to provide an audio signal to an audio output apparatus. It will be understood that the depicted embodiment may be implemented using the hardware and software components of the systems and devices described above, or via any other suitable hardware and software components.

At 402, the computing device generates and sends an audio signal to the audio output apparatus for the generation of sound by the audio output apparatus. At 404 the audio output apparatus generates a first information stream via a first context sensor, such as a motion sensor, and at 406, sends the first information stream to the computing device.

At 408, the audio output apparatus generates a second information stream via a second context sensor, and at 410 sends the second information stream to the computing device. The second context sensor may be an environmental sensor such as an omnidirectional microphone, a light sensor, or a touch sensor. It will be understood that some embodiments may comprise a motion sensor but not an environmental sensor, while other embodiments may comprise an environmental sensor but not a motion sensor. As such, it will be understood that the nature of and number of sensor signals provided to the computing device may vary.

At 412, the computing device receives a first input from the each context sensor, and at 414, activates a selected listening mode selected from a plurality of listening modes based on the first input(s). As previously discussed with reference to FIG. 3, each listening mode defines a mapping of a set of context sensor inputs to a set of computing device functionalities, wherein each listening mode may enable a different set of functionalities.

Continuing with FIG. 4, at 416 the audio output apparatus receives a second input from each context sensor, and at 418, selectively triggers the execution of a selected computing device functionality from the set of computing device functionalities based on the second input(s). Then, at 420, the computing device transforms the audio signal supplied to the audio output apparatus based on the selected computing device functionality. For example, the computing device may pause playback, resume playback, adjust a volume or output power as a function of frequency, select a media selection based upon tempo or other factor, or perform any other suitable adjustment of the output audio signal.

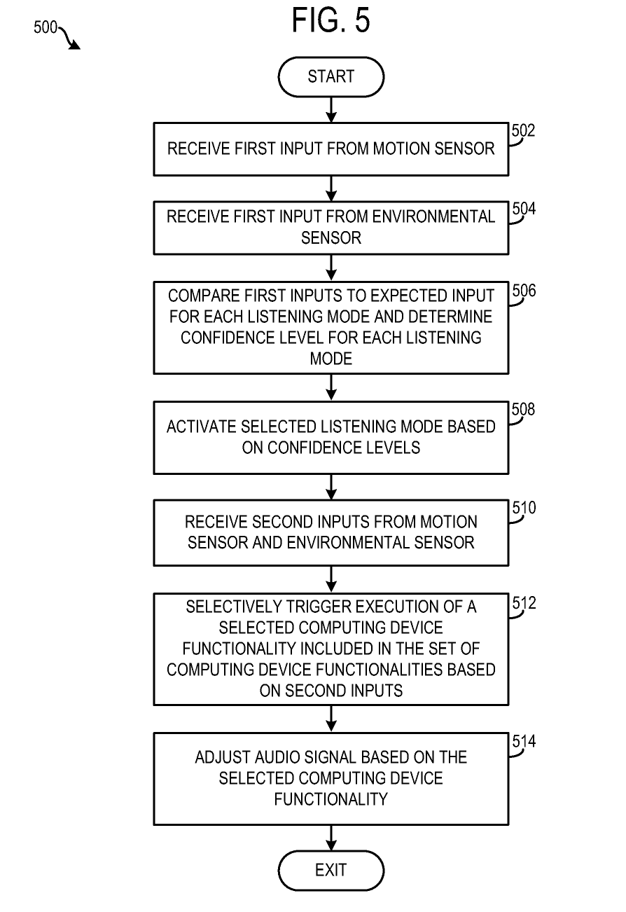

FIG. 5 shows a flow diagram depicting a more detailed embodiment of a method 500 for managing a set of predetermined listening modes, wherein each listening mode defines a mapping of a set of inputs received from a set of sensors, such as an accelerometer and an environmental sensor associated with the audio output apparatus, to a set of computing device functionalities. It will be understood that method 500 may be implemented using the hardware and software components of the embodiments described herein, and/or via any other suitable hardware and software components.

First at 502, method 500 includes receiving a first input from the accelerometer, and at 504, receiving a first input from the environmental sensor. In some examples the first input from the environmental sensor may include input from one or more of a motion sensor, a touch sensor, a light sensor, and a sound sensor. Next, at 506, method 500 includes comparing the first input from each sensor to an expected input from each sensor for each listening mode to determine a confidence level for each listening mode. Then, at 508, method 500 includes activating a selected listening selected from the set of predetermined listening modes based on the confidence levels. In some embodiments, the listening mode with the highest confidence level may be selected. However, in other, embodiments other criteria may be used to select the listening mode.

Next, at 510, method 500 includes receiving a second input from the accelerometer and a second input from the environmental sensor, and at 512, selectively triggering execution of a selected computing device functionality included in the set of computing device functionalities based on these second inputs. At 514 method 500 includes transforming an audio signal supplied to the audio output apparatus based on the selected computing device functionality. The audio signal may be transformed in any suitable manner. For example, a volume, an equalization, or other audio characteristic of the signal may be adjusted. Likewise, playback may be stopped, paused, resumed, etc. Further, an audio track may be selected based upon tempo or other factors.

It is to be understood that the configurations and/or approaches described herein described for the purpose of example, and that these specific embodiments are not to be considered in a limiting sense, because numerous variations are possible. The specific routines or methods described herein may represent one or more of any number of processing strategies. As such, various acts illustrated may be performed in the sequence illustrated, in other sequences, in parallel, or in some cases omitted. Likewise, the order of the above-described processes may be changed.

The subject matter of the present disclosure includes all novel and nonobvious combinations and subcombinations of the various processes, systems and configurations, and other features, functions, acts, and/or properties disclosed herein, as well as any and all equivalents thereof.

1. A computing device configured to be coupled to an audio output apparatus that comprises a context sensor, the computing device comprising:
a logic subsystem; and
a storage subsystem comprising instructions executable by the logic subsystem to:
receive a first input from the context sensor;
activate a selected listening mode selected from a plurality of listening modes based on the first input, the listening mode defining a mapping of a set of context sensor inputs to a set of computing device functionalities;
after activating the selected listening mode, to receive a second input from the context sensor;
selectively trigger execution of a selected computing device functionality from the set of computing device functionalities based on the second input; and
adjust an audio signal supplied to the audio output apparatus based on the selected computing device functionality.

2. The computing device of claim 1, wherein the first input from the context sensor comprises input from one or more of a motion sensor, a touch sensor, a light sensor, and a sound sensor.

3. The computing device of claim 2, wherein receiving the first input comprises receiving a plurality of first inputs from a plurality of context sensors, and activating the selected listening mode comprises activating the selected listening mode from the plurality of listening modes based on the plurality of first inputs.

4. The computing device of claim 2, wherein receiving the second input comprises receiving a plurality of second inputs from a plurality of context sensors, and selectively triggering execution of the selected computing device functionality comprises selectively triggering execution of the selected computing device functionality based upon the plurality of second inputs.

5. The computing device of claim 1, wherein the listening mode comprises a general activity mode and the set of computing device functionalities corresponding to the mobile-activity mode comprises one or more of a volume adjustment function and an equalizer adjustment function.

6. The computing device of claim 5, wherein the listening mode comprises a specific activity mode configured to be selected during aerobic exercise, and wherein the set of functionalities comprises a tempo selection functionality configured to select an audio track based upon an exercise tempo.

7. The computing device of claim 1, wherein the listening mode comprises a stationary mode and the set of computing device functionalities corresponding to the stationary mode comprises one or more of a pause function, a resume function, and a mute function.

8. The computing device of claim 7, wherein the audio signal comprises a streaming audio signal, and wherein the pause function comprises a stream buffer function configured to buffer a segment of data beginning at a pause point in the streaming audio signal.

9. The computing device of claim 1, wherein the computing device comprises a portable media player or a portable telephone.

10. An audio output apparatus configured to receive an audio signal from a computing device via an input interface and to provide a feedback signal to the computing device via an output interface, the audio output apparatus comprising:
a body;
a motion sensor configured to generate a first feedback stream and send the first information stream to the output interface, the motion sensor being coupled to the body;
an environmental sensor configured to generate a second information stream and send the second information stream to the output interface, the environmental sensor being coupled to the body; and
a speaker coupled to the body and configured to receive an audio signal from the input interface and to produce sounds from the audio signal.

11. The audio output apparatus of claim 10, wherein the motion sensor is an accelerometer.

12. The audio output apparatus of claim 10, wherein the environmental sensor is an omnidirectional microphone configured to detect ambient sounds.

13. The audio output apparatus of claim 10, further comprising an earpiece supporting the speaker, wherein the environmental sensor comprises one or more of a light sensor and a touch sensor coupled to the earpiece.

14. The audio output apparatus of claim 10, wherein the audio output apparatus is a personal headphone apparatus.

15. The audio output apparatus of claim 10, further comprising a unidirectional microphone configured to provide telephony communication.

16. The audio output apparatus of claim 10, wherein the input interface and the output interface communicate with the computing device via wireless communication.

17. In a computing device configured to be connected to an audio output apparatus, a method for managing a set of predetermined listening modes, each listening mode defining a mapping of a set of inputs received from an accelerometer and an environmental sensor associated with the audio output apparatus to a set of computing device functionalities, the method comprising:
receiving a first input from the accelerometer;
receiving a first input from the environmental sensor;
comparing the first input from the accelerometer and the first input from the environmental sensor to an expected first input from the accelerometer and an expected first input from the environmental sensor for each listening mode;
determining a confidence level for each listening mode of the plurality of listening modes;
activating a selected listening selected from the set of predetermined listening modes based on the confidence levels;
receiving a second input from the accelerometer and a second input from the environmental sensor;
selectively triggering execution of a selected computing device functionality included in the set of computing device functionalities based on the second input from the accelerometer and the second input from the environmental sensor; and
transforming an audio signal supplied to the audio output apparatus based on the selected computing device functionality.

18. The method of claim 17, wherein the first input from the environmental sensor comprises input from one or more of a touch sensor, a light sensor, and a sound sensor.

19. The method of claim 17, wherein the listening mode comprises a general activity mode and wherein the set of computing device functionalities corresponding to the mobile-activity mode comprises one or more of a volume adjustment function and an equalizer adjustment function.

20. The method of claim 17, wherein the listening mode comprises a stationary mode and wherein the set of computing device functionalities corresponding to the stationary mode comprises one or more of a pause function, a resume function, and a mute function.
